(19) United States
(12) Patent Application Publication
(10) Pub. No.: US 2010/0078367 A1
(43) Pub. Date: Apr. 1, 2010

(54) FIELD RELIEF RESERVOIR FOR SEPTIC FIELD SYSTEM

(76) Inventors: ROBERT RONALD OROM, Sylvan Lake (CA); DALE WESLEY MASON, Caroline (CA)

Correspondence Address: BENNETT JONES LLP;C/O MS ROSEANN CALDWELL, 4500 BANKERS HALL EAST, 855 - 2ND STREET, SW, CALGARY, AB, T2P 4K7, CA

(21) Appl. No.: 12/570,207

(22) Filed: Sep. 30, 2009

Related U.S. Application Data
(60) Provisional application No. 61/101,392, filed on Sep. 30, 2008.

(51) Int. Cl. C02F 11/12; B01D 21/24

(52) U.S. Cl. 210/86; 210/170.08

(57) ABSTRACT

A reservoir and a septic system are provided. The reservoir can have a wall having a top end and a bottom end, an opening at the top end of the wall, a floor at the bottom end of the wall, an internal cavity defined by the wall and the floor and an inlet passing into the internal cavity above the floor. The septic system can comprise a septic tank, at least one liquid permeable leaching channel connected to the septic tank and at least one of the reservoirs. The reservoir positioned partially in the ground such that the top end of the reservoir is positioned above the ground and the bottom end of the reservoir is positioned below the ground with the inlet of the reservoir connected to the at least one leaching channel.

### CROSS REFERENCE TO RELATED APPLICATIONS

This application claims priority under 35 U.S.C. 119(e) to U.S. provisional patent application No. 61/101,392, filed Sep. 30, 2008.

### FIELD OF THE INVENTION

The present invention relates to septic systems which use a drain field and more particularly to monitoring the performance of the drain field.

### BACKGROUND OF THE INVENTION

Houses and other buildings in rural places or small communities that do not have access to a sewer system typically use a septic system. A common form of septic system is a drain field system, which uses a septic tank and a drain field (also commonly called a leaching bed, absorption field, etc.) to deal with wastewater from a building.

In these systems, wastewater from a building is first discharged into the septic tank, where it undergoes some preliminary treatment. From the septic tank, the effluent is directed down leaching channels passing below the ground surface in the drain field, where under ideal conditions, the effluent percolates into the soil in the drain field surrounding the leaching channels. The soil acts as a filter for the discharged effluent, treating the discharged effluent by bacterial action and oxidation beneath the ground surface.

The septic tank is connected to the outgoing wastewater lines (e.g. grey water, sewage, etc.) of the building and is used to provide some preliminary treatment to the wastewater, typically to remove solids from the wastewater as well as breaking down some of the organic matter in the wastewater, to try and prevent the solid matter from clogging the leaching channels.

Although single chamber septic tanks are sometimes used, typically, two-chamber septic tanks are used in drain field systems. In a two-chamber septic tank, the wastewater from the building is directed into the first chamber of the septic tank, where heavier solids settle out of the wastewater and fall to the bottom of the tank forming a layer of “sludge”, while lighter materials (i.e. grease and fat) rise to the surface, forming a layer of “scum”. Periodically, the sludge layer and scum layer has to be removed by pumping out the septic tank.

With at least some of the solids and lighter materials removed from the wastewater, the wastewater is typically referred to as “clarified effluent”. This clarified effluent passes from the first chamber to the second chamber in the septic tank. At the end of the first chamber is a partition separating the second chamber from the first chamber. An opening is provided in this partition that allows the clarified effluent in the first chamber to pass into the second chamber. This opening is positioned in the partition at a specific height so that the opening is lower than the surface of the effluent in the septic tank, preventing the layer of scum in the first chamber from passing into the second chamber, but high enough from the bottom of the partition so that the solids or sludge in the first chamber do not pass into the second chamber.

From the second chamber, the clarified effluent is then routed (e.g. pumped or gravity fed, depending on the height of the drain field and other factors) to the drain field. The drain field has a number of leaching channels that distribute the effluent into the soil throughout the drain field. The size and number of leaching channels in a given septic drain field system will vary depending on local regulations and the size of the building the septic system is serving.

These leaching channels used to be commonly constructed from plastic perforated pipes placed in gravel trenches running below the ground surface or even clay tiles in older systems. As effluent passes through the perforated pipes, the effluent leaks out of the pipes through the perforations, percolating through the gravel and seeping into the surrounding soil. Newer septic field systems, however, often use leaching channels that are formed from a number of plastic chambers that attach together easily to allow installers to vary the lengths of the leaching channels based on specific applications. These chambers are open at their bottoms so that effluent passing through the leaching channels is in contact with the soil below. The leaching channels attempt to distribute effluent along their length thereby utilizing a greater amount of soil in the drain field to treat the effluent.

Because the septic field system uses a number of leaching channels, a distribution system is used to try and provide an even distribution of the effluent between the different leaching channels. Uneven distribution of the effluent to the leaching channels can overload one area of the septic field system, causing a specific area in the drain field to receive more effluent than other areas. Although a number of different systems of distribution are used, a commonly used system is a distribution box. The distribution box is a tank-like box with an inlet through which the effluent flows into the distribution box and a number of outlets leading out of the distribution box, with each outlet connected to a conduit directing the exiting effluent to one of the leaching channels.

Ideally, when the septic system is working properly, wastewater from the building is directed into the septic tank, where it is clarified or partially clarified. The clarified effluent is then discharged from the septic tank to the distribution system for the drain field (i.e. the distribution box) where it is distributed more or less evenly between the different leaching channels. Once the effluent has been directed to one of the leaching channels, the effluent flows along the leaching channel until it seeps into the soil surrounding the leaching channel (e.g. exiting through the perforations if the leaching channels are perforated pipe or exiting through the open-bottoms or perforations in the sides of the newer plastic chamber assemblies). Ideally, the effluent should not flow down the entire length of the leaching channel, but rather should be slowly seeping out of the leaching channel, along the entire length of the leaching channel, so that very little if any of the effluent reaches the far end of the leaching channel. In many cases, the ends of the leaching channels are capped to prevent effluent that manages to flow the entire length of the leaching channel from exiting the leaching channel in a large amount at the far end.

However, problems do occur with septic field systems and because most of the components of the drain field are buried below the ground surface (for example, the leaching channels are typically buried 12″ to 16″ below the ground surface), these problems are very hard to diagnose before they become serious and in many cases hard to address even after it becomes apparent that a problem has occurred.

One problem that can occur is that if the soil surrounding the leaching channels becomes saturated with moisture the effluent can be prevented from entering the soil. This can occur for a number of reasons including if too much sewage is being ejected from the house, heavy rainfall or repeated rainfalls have occurred naturally saturating the soil, or in spring where snow previously covering the ground has melted. It can also occur if the septic field system is not evenly distributing the effluent among the different leaching channels causing one or more of the leaching channels to receive a disproportionately high volume of effluent, overwhelming the soil surrounding these leaching channels. The saturated soil can prevent effluent in the leaching channel from seeping out of the leaching channel, causing a substantial portion, if not almost all, of the effluent to remain in the leaching channel, eventually filling the leaching channel right to its far end.

With the previous systems, it is often not readily apparent what is occurring in the septic field system and especially the drain field portion of the system because many of the components making up the drain field are buried below the ground surface. In particular, the leaching channels are buried beneath the ground surface, so a person cannot see into them without digging down to them and opening them up, making it impossible to tell directly if there is effluent collecting in the leaching channels rather than seeping in the soil. Previously, problems with a drain field were diagnosed using indirect indicators such as the ground surface of the drain field being spongy or soggy, the formation of puddles of effluent on the ground surface, smell of sewage from the drain field, slow drainage of waster water in the building through toilets and drains or even backing up of the sewage, etc. These indirect indicators are not conclusive of a problem with the drain field and can often be a result of a number of different problems with a septic system. Additionally, these indirect indicators usually do not occur shortly after a problem occurs. In many cases, a significant period of time is needed for the indicators to begin to show (i.e. a build up of effluent to the point that it forms puddles on the ground surface of the drain field) which can result in the problems becoming quite serious before a person becomes aware that problems are occurring. Problems in these previous systems were not easy to diagnose and even when indirect indicators occur they are not necessarily conclusive of what is causing the problem.

Additionally, even when a problem with a drain field has been discovered, it is not always easy to remedy. Because the leaching channels are buried below the ground surface, even when it becomes apparent that the leaching channels are full of effluent, there is not much that can be done in the these systems besides digging up the leaching channels to empty them or simply waiting for the ground to become unsaturated and the effluent in the leaching channels to seep into the soil. Additionally, if the saturation is caused by natural temporary causes (e.g. heavy rainfall) it is not desirable to dig up the leaching channels to address a temporary problem.

It will therefore be appreciated that there exists a need for a method and system that overcomes problems in the prior art.

### SUMMARY OF THE INVENTION

In an aspect, a septic system is provided. The septic system comprises: a septic tank; at least one liquid permeable leaching channel positioned below a ground surface and having a first end operatively connected to the septic tank and a second end; and at least one reservoir. The reservoir comprises: at least one wall having a top end and a bottom end, the wall defining an opening at the top end of the at least one wall; a floor connected to the bottom end of the at least one wall; an internal cavity defined by the at least one wall and the floor; and an inlet passing into the internal cavity above the floor. The at least one reservoir is positioned partially in the ground such that the top end of the reservoir is positioned above the ground surface and the bottom end of the reservoir is positioned below the ground surface, the inlet of the reservoir operatively connected to the second end of the at least one leaching channel.

In a further aspect, a reservoir for connection to the end of a leaching channel is provided. The reservoir comprises: at least one wall having a top end and a bottom end, the wall defining an opening at the top end of the at least one wall; a floor connected to the bottom end of the at least one wall; an internal cavity defined by the at least one wall and the floor; an inlet passing into the internal cavity above the floor; and a plurality of protrusions extending outwards from the at least one wall to help secure the reservoir in the ground.

The reservoir is installed as a component of a septic system that uses a drain field. The septic system has a septic tank and a number of leaching chambers, with each of the leaching chambers having a first end and a second end. From the septic tank, partially-treated effluent is discharged to the various leaching chambers. Each leaching chamber is liquid permeable so that the effluent directed to a leaching chamber can seep out of the leaching chamber as it passes along the length of the leaching chamber and into the soil below the leaching chamber. A reservoir is connected to the second end of each of the leaching chambers.

When the septic system is in use, if effluent begins to fill a leaching chamber right to the second end of the leaching chamber, some of the effluent at the second end of the leaching chamber is discharged out the second end of the leaching chamber and into the internal cavity of the reservoir. Because the reservoir has an opening positioned above the ground surface, a person can determine whether the leaching chamber attached to the reservoir has become filled with effluent by checking if effluent is collecting inside the reservoir, allowing the person to diagnose problems with the drain field.

In a further aspect, the leaching chamber can be at least partially drained of effluent by using a vacuum truck to remove the effluent collecting in a reservoir.

In a further aspect, the outer surface of the reservoir contains a number of protrusions extending outwards from the outer surface that help anchor the reservoir in place when it is partially buried in the ground.

In a further aspect, the reservoir is formed of an outer layer and an inner layer that together surround an insulting layer so that the reservoir can be used in climates where the winter gets cold enough to freeze.

In another aspect, the reservoir has an outlet passing into the internal cavity, in addition to the inlet. In one aspect, the outlet is provided above the inlet. The outlet allows the reservoir to be connected to an overflow leaching channel so that if effluent collects in the reservoir to the point where it reaches the level of the outlet, the effluent is discharged to the overflow leaching channel rather than continuing to fill the reservoir and eventually overflowing the reservoir.

### BRIEF DESCRIPTION OF THE DRAWINGS

Referring to the drawings wherein like reference numerals indicate similar parts throughout the several views, several aspects of the present invention are illustrated by way of example, and not by way of limitation, in detail in the figures, wherein:

FIG. 1 is a perspective view of a reservoir;

FIG. 2 is a top view of the reservoir shown in FIG. 1;

FIG. 3 is a side sectional view, along sectional line AA′ in FIG. 2, of the reservoir;

FIG. 4 is a side sectional view of the reservoir, shown in FIG. 3, with a first lid and second lid in place to seal an opening of the reservoir;

FIG. 5 is a schematic illustration of a septic system incorporating the reservoir shown in FIG. 1;

FIG. 6 is a schematic illustration of a leaching channel in the septic system shown in FIG. 4;

FIG. 7 is a perspective view of a reservoir in a second aspect;

FIG. 8 is a top view of the reservoir shown in FIG. 6;

FIG. 9 is a side sectional view, along sectional line BB′ in FIG. 8, of the reservoir;

FIG. 10 is a schematic illustration of a septic system incorporating the reservoir shown in FIG. 7; and

FIG. 11 is a side sectional view of the reservoir shown in FIG. 3, with a level indicator provided.

### DESCRIPTION OF VARIOUS EMBODIMENTS

The detailed description set forth below in connection with the appended drawings is intended as a description of various embodiments of the present invention and is not intended to represent the only embodiments contemplated by the inventor. The detailed description includes specific details for the purpose of providing a comprehensive understanding of the present invention. However, it will be apparent to those skilled in the art that the present invention may be practiced without these specific details.

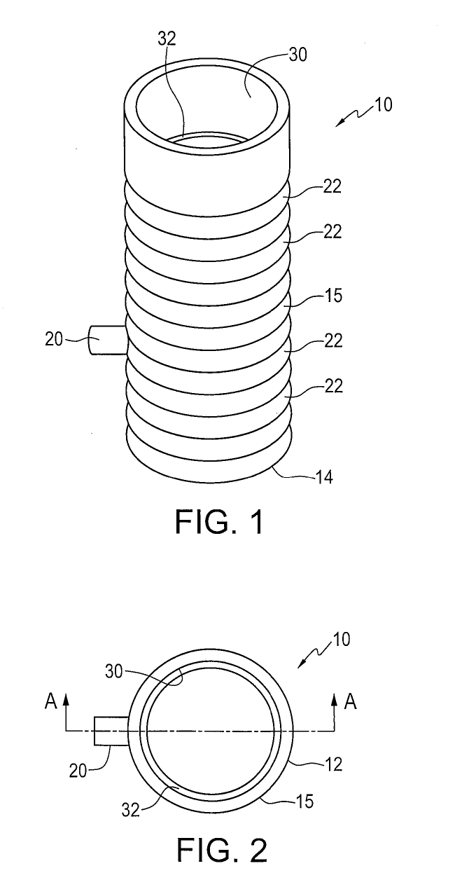

FIGS. 1 and 2 illustrate a reservoir 10 for installation at the end of a leaching channel (not shown) in a septic field system. The reservoir 10 has a top end 12 and a bottom end 14 with a wall 15 passing between the top end 12 and bottom end 14. An inlet 20 is provided passing through the wall 15 of the reservoir 10 and an opening 30 is provided at the top end 12 of the reservoir 10.

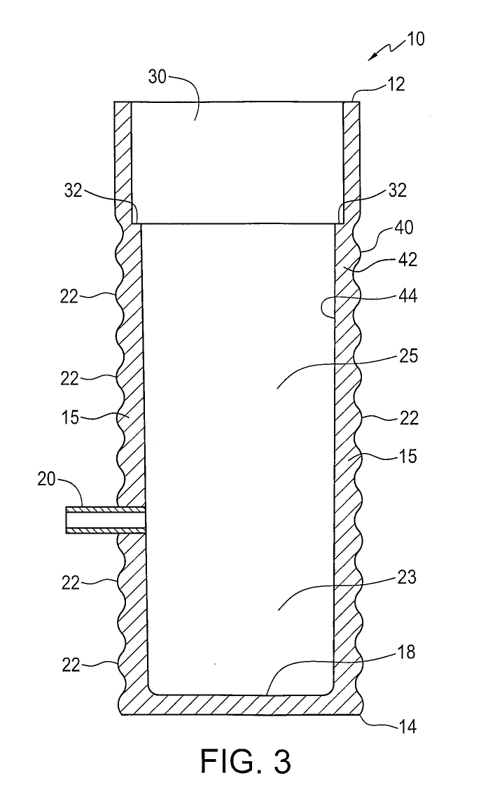

FIG. 3 illustrates a side sectional view of the reservoir 10 along sectional line AA′ in FIG. 2. The wall 15, running between the top end 12 and the bottom end 14 of the reservoir 10, in conjunction with a floor 18 define a cavity 25 inside the reservoir 10. The inlet 20 is in fluid communication with the cavity 25 allowing liquids directed through the inlet 20 to pass into the cavity 25. The portion of the cavity 25 located below the inlet 20 forms a collection zone 23, where liquids passing into the cavity 25 through the inlet 20 will collect.

With the inlet 20 connected to an end of a leaching channel (not shown), if the leaching channel becomes filled right to the far end with effluent, some of the effluent will pass out of the far end of the leaching channel, through the inlet 20 and into the cavity 25 of the reservoir 10 where it will collect in the collection zone 23.

When the reservoir 10 is installed in place as part of a septic system, the reservoir 10 is partially buried in the ground so that the bottom end 14 of the reservoir 10 is buried below the ground surface and the top end 12 of the reservoir extends above the ground surface, so that the mouth 30 of the reservoir 10 remains above the ground surface. To help secure the reservoir 10 in place in the ground and to prevent flotation of the reservoir 10 if the soil surrounding the reservoir 10 starts to become saturated with liquid, the wall 15 can contain a number of protrusions 22 or ridges to help to secure the reservoir 10 in the ground.

In one aspect, the reservoir 10 can be insulated for use in climates that become cold enough for liquids to freeze in the winter. In an aspect, the wall 15 and the floor 18 are formed with an outer layer 40, an insulating layer 42 and an inner layer 44. The inner layer 44 and the outer layer 40 are formed of water-impermeable thermoplastic and together the inner layer 44 and the outer layer 40 encapsulate the insulating layer 42. The insulating layer 42 could simply be an air space or it could contain insulating material such as foam insulation, etc. In this manner, the insulating layer 42 serves to help insulate liquid collected in the cavity 25 from the temperature of the surrounding ground and air to help prevent the liquid from freezing in cold weather.

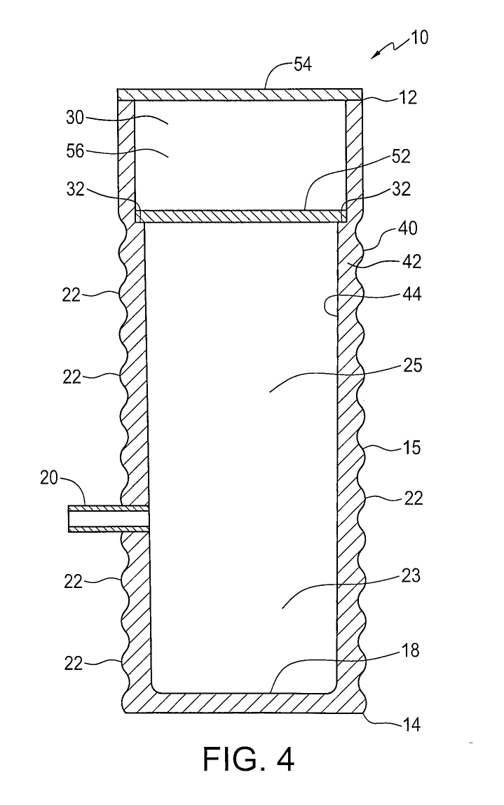

The reservoir 10 could be constructed so that it has only a single lid to cover the opening 30, however, in one aspect, a two-part lid system is used to insulate the cavity 25 from the temperature of the surroundings. FIG. 4 illustrates a first lid 52 and a second lid 54 for sealing the opening 30 of the reservoir 10. The first lid 52 is sized to fit inside the opening 30 of the reservoir 10 and rest on an inner lip 32 located above the cavity 25. A second lid 54 is sized to fit over the opening 30 at the top end 12 of the reservoir 10. The first lid 52 and second lid 54 can be secured in place with screws or some other suitable attachment mechanism. In this manner, an air space 56 is created between the first lid 52 and the second lid 54 helping to insulate the internal cavity 25 and any liquid contained in the internal cavity 25 from the air and surroundings at the mouth of the opening 30.

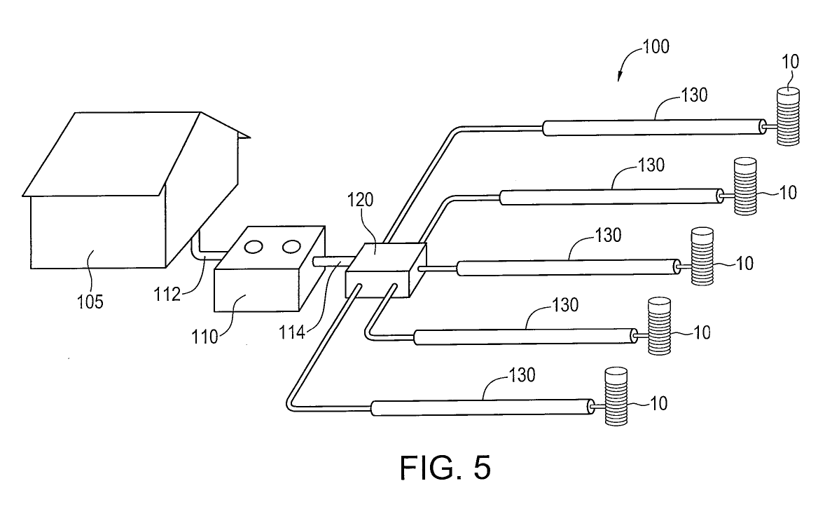

FIG. 5 is a schematic illustration of a septic system 100. The septic system 100 has a septic tank 110, a distribution box 120 and a plurality of liquid permeable leaching channels 130. Each of the leaching channels 130 terminates with a reservoir 10.

Wastewater from a building 105 enters the septic system 100 by first entering the septic tank 110 though an inlet conduit 112, typically connected to the building 105. In the septic tank 110, the wastewater is clarified and eventually exits the septic tank 110 through an outlet conduit 114. The outlet conduit 114 directs the clarified effluent exiting the septic tank 110 to a distribution box 120. The clarified effluent can be gravity fed or pumped from the septic tank 110 to the distribution box 120 through the outlet conduit 114.

Once the effluent is in the distribution box 120, the effluent is directed to one of the leaching channels 130, where the effluent will flow along a length of the leaching channel 130 until it passes out of the leaching channel 130 and into the soil surrounding the leaching channel 130 or until the effluent reaches a far end of the leaching channel 130.

In one aspect, a single reservoir 10 could be connected to more than one leaching channel 130.

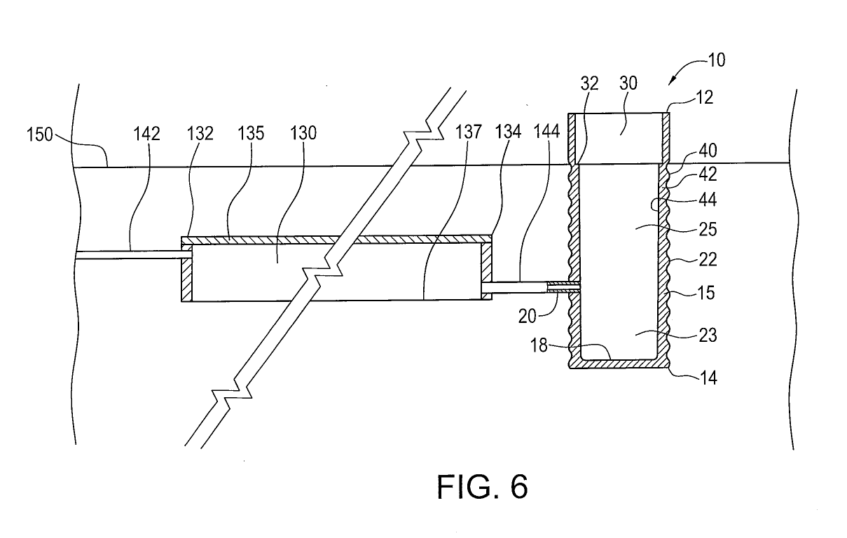

FIG. 6 is a schematic illustration of a liquid permeable leaching channel 130 installed below a ground surface 150 and connected to a reservoir 10. Effluent passes into the leaching channel 130 through an inlet conduit 142. The inlet conduit 142 is provided at a first end 132 of the leaching channel 130, proximate a top 135 of the leaching channel 130. Because the inlet conduit 142 is positioned proximate to the top 135 of the leaching channel 130, any effluent entering the leaching channel 130 through the inlet conduit 135 will move towards the second end 134 of the leaching channel 130 (unless the effluent has already filled the entire length of the leaching channel 130). The effluent passes along the length of the leaching channel 130 towards the second end 134 of the leaching channel 130 until it passes into the soil adjacent to the leaching channel 130.

The distance the effluent will pass along the length of the leaching channel 130 towards the second end 124 will depend on a number of variables including the amount of moisture in the soil adjacent to the leaching channel 130 and the flowrate of the effluent entering the leaching channel 130 from the inlet conduit 142. If the moisture level of the soil surrounding the leaching channel 130 is relatively low and the flowrate of the effluent entering the leaching channel 130 from the inlet conduit 142 is relatively low, the effluent may only travel a short distance along the length of the leaching channel 130. However, if the adjacent soil contains a substantial amount of moisture and/or a substantial amount of effluent is flowing into the leaching channel 130 from the inlet conduit 142, the effluent can travel a substantial portion of the length of the leaching channel 130. In some cases, such as when the surrounding soil is completely saturated, the effluent can travel the entire length of the leaching channel 130 to the second end 134 of the leaching channel 130.

The second end 134 of the leaching channel 130 is typically capped off so that the effluent cannot simply pass out the second end 134 of the leaching channel 130, causing a concentration of effluent in the soil at the second end 134 of the leaching channel 130. An outlet conduit 144 is provided at this second end 134 of the leaching channel 130 operatively connected to the inlet 20 of the reservoir 10 positioned at the end of the leaching channel 130. In an aspect, the outlet conduit 144 is provided proximate to the bottom end 137 of the leaching channel 130 and in an aspect is positioned so that it is lower than the inlet conduit 142 at the first end 132 of the leaching channel 130.

Referring to FIGS. 1 through 6, in operation a person can relatively quickly determine the performance of the septic system 100, determining how well the drain field is operating and checking whether effluent is building up in any of the leaching channels 130, rather than percolating into the soil, as it should if the septic system 100 is operating properly. By removing the first lid 52 and the second lid 54 from the opening 30 of the reservoir, a person can check the cavity 25 of the reservoirs 10 to see if any effluent has collected in the cavity 25. If effluent is collecting in the cavity 25, it may be that the leaching channel 130 that the reservoir 10 is connected to is filled with effluent that is not leaching quickly enough into the soil surrounding the leaching channel 130. If all or many of the reservoirs 10 have effluent collecting in them, this could indicate that the entire drain field is saturated with liquid. Alternatively, if only one of the reservoirs 10 or a very few of the reservoirs 10 have effluent collecting in them, while the other reservoirs 10 do not, this could indicate that the effluent from the septic tank 110 is not being evenly distributed among the leaching channels 130 and therefore the leaching channels 130 connected to the reservoirs 10, which have effluent collecting in them, are receiving a disproportionately higher amount of effluent than the other leaching channel 130.

In an aspect, the reservoirs 10 can also be used to remove effluent from the leaching channel 130, in addition to being used to diagnose problems with the septic system 100. Using a vacuum truck (not shown), the hose of the vacuum truck can be inserted into the collection zone 23 of the cavity 25 of the reservoir 10 to remove the effluent collected in the reservoir 10. If the outlet conduit 144 of the leaching channel 130 is positioned below the inlet conduit 142 of the leaching channel 130 and/or the leaching channel 130 is sloped slightly downwards along its length, the vacuum truck can also remove some of the effluent collecting in the leaching channel 130. As the vacuum truck removes the effluent from the cavity 25 of the reservoir 10, the level of the effluent in the cavity 25 will fall below the inlet 20 of the reservoir. With the effluent falling below the level of the inlet 20, more effluent is drawn out of the second end 134 of the leaching channel 130, to replace the effluent removed from the reservoir 10 by the vacuum truck. This effluent will also be removed by the vacuum truck. This can continue until the level of the effluent in the second end 134 of the leaching channel 130 falls below the outlet conduit 144. In this manner, not only can the vacuum truck remove effluent that has collected in the reservoir 10, but it can also remove effluent from the leaching channels 130.

If the leaching channel 130 is sloped slightly downwards from the first end 132 to the second end 134 of the leaching channel 130, a substantial portion of the effluent in the leaching channel 130 could be removed in this manner.

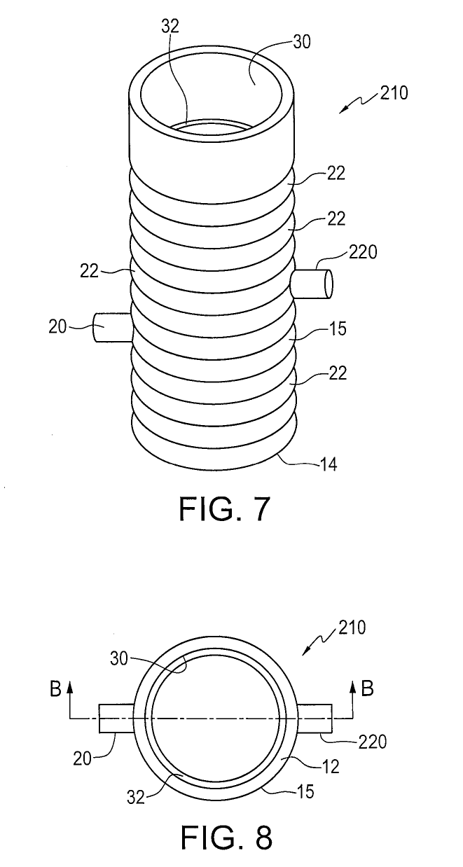

FIGS. 7, 8 and 9 illustrate a reservoir 210 in a further aspect. In addition to the inlet 20 passing into the cavity 25, reservoir 210 has an outlet 220 that also passes out of the cavity 25 of the reservoir 210. In an aspect, the outlet 220 is provided at a higher point then the inlet 20. The reservoir 210 can be used in a septic system designed to prevent the reservoir 210 from overflowing if too much effluent collects in the reservoir 210.

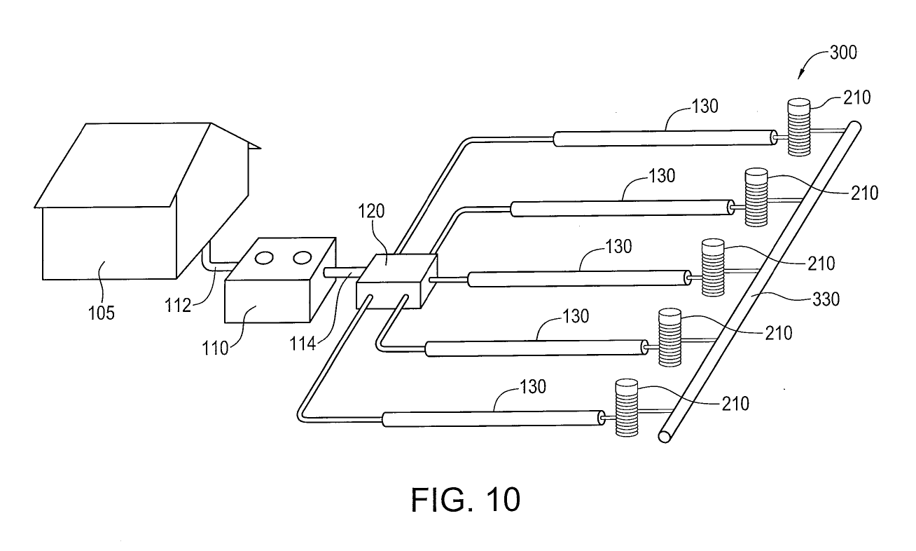

FIG. 10 illustrates a schematic illustration of a septic system 300, in an aspect, incorporating a number of reservoirs 210. The septic system 300 has a septic tank 110, a distribution box 120 and a plurality of leaching channels 130. Each of the leaching channels 130 terminates with a reservoir 210. An additional overflow leaching channel 330 is connected to the reservoirs 210.

Wastewater from a building 105 enters the septic system 300 by first entering the septic tank 110 though an inlet conduit 112, typically connected to the building 105. In the septic tank 110, the wastewater is clarified and eventually exits the septic tank 110 and directed to the distribution box 120 to be distributed among the different leaching channels 130 where, ideally, the effluent will seep into the soil adjacent to the leaching channels 130.

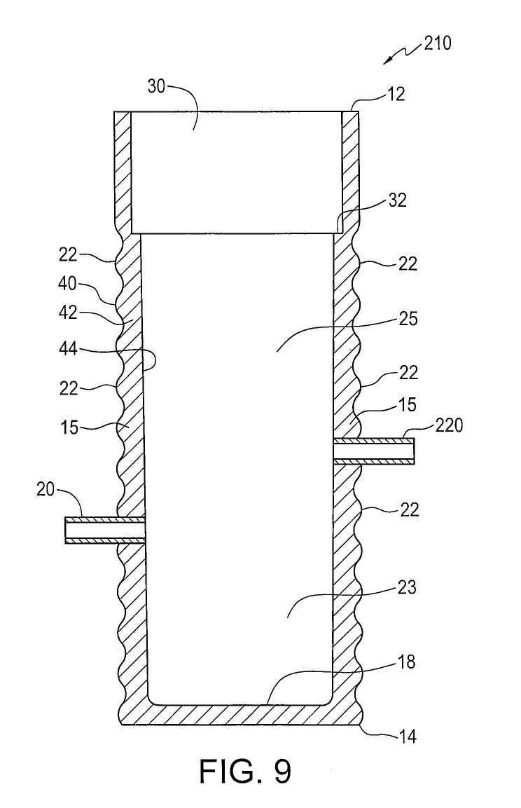

Referring to FIGS. 9 and 10, during the operation of septic system 300, if one of the leaching channels 130 becomes filled with effluent and in turn fills the reservoir 210 connected to the leaching channel 130 with effluent up to the outlet 220 of the reservoir 210, the outlet 220 of the reservoir 210 can discharge some of this collecting effluent to the overflow leaching channel 330 before the effluent completely fills and possible overflows the reservoir 210.

Each reservoir 210 can be used to gauge the performance of the leaching channel 130 the reservoir 210 is connected to. A person can check if effluent is collecting in the cavity 25 of the reservoir 210 by peering through the mouth 30 of the reservoir 210. However, if the level of effluent reaches the outlet 220 of the reservoir 210, the effluent is discharged through the outlet 220. In this manner, a person can see the level of the effluent in the reservoir 210 and as long as the effluent is not rising much past the outlet 220 just leave the effluent in the reservoir 210.

In a further aspect, the reservoir 210 can also be used to remove effluent collecting in the leaching channels 130 the reservoir 210 is connected to, by placing the hose of a vacuum truck (not shown) into the collection zone 23 of the cavity 25 and removing the effluent. In this manner, not only can the effluent be removed from the cavity 25 of the reservoir 210, but also some of the effluent collecting in the leaching channel 130 can also be removed.

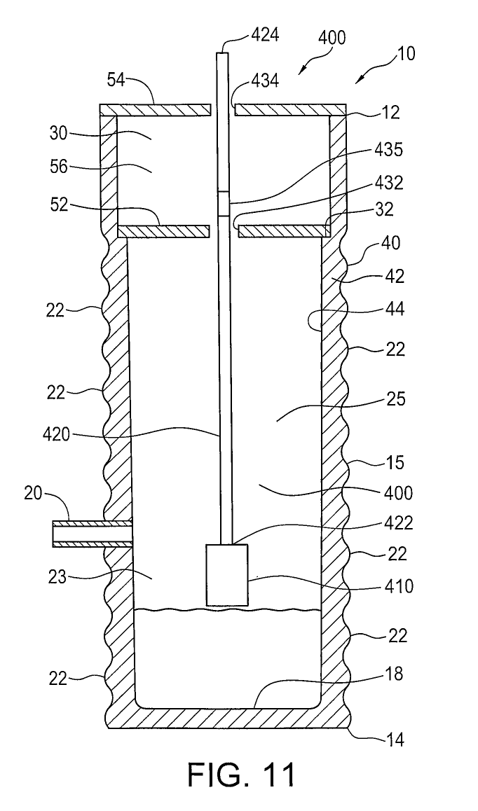

FIG. 11 illustrates the reservoir 10 shown in FIGS. 1-5 with a level indicator 400. The level indictor 400 can have a pole 420 with and elongate shaft extending between a first end 422 and a second end 424. A float 410 can be attached to the first end 422 of the pole 420.

The level indicator 400 can be provided in the reservoir 10 and used to determine the height of effluent in the cavity 25 of the reservoir 10 without having to remove the lids 52, 54. The level indicator 410 can be provided in the reservoir 10 with the float 410 and the second end 422 of the pole 420 extending down into the cavity 25 of the reservoir 10 and the pole 420 extended upwards and through an aperture 432 in the first lid 52 and an aperture 434 in the second lid 54 so that the second end 424 of the pole 420 extends out of and above the top end 12 of the reservoir 10.

As effluent builds up in the cavity 25 of the reservoir 10, the float 410 can float on top of the effluent in the cavity 25 raising the second end 424 of the pole 420 higher above the top end 12 of the reservoir 10. By viewing the height that the second end 424 of the pole 420 extends above the top end 12 of the reservoir 10, a person can gauge how much effluent has collected in the cavity 25 of the reservoir 10 without having to remove the lids 52, 54 and peer inside. The higher the second end 424 of the pole 420 is extending above the top end 12 of the reservoir 10, the more effluent that has collected in the reservoir 10.

In one aspect, a portion of the pole 420 can be marked with a full indicator marking 435, such as a different colored portion, writing on the pole 420, etc. The full indicator 435 can be used to indicate when enough effluent has collected in the reservoir 10 that the reservoir 10 should be checked. When the portion of the pole 420 where the full indicator marking 435 is visible above lid 54 and the top end 12 of the reservoir 10, a person will know that they should check the levels of effluent that have collected inside the reservoir 10.

The previous description of the disclosed embodiments is provided to enable any person skilled in the art to make or use the present invention. Various modifications to those embodiments will be readily apparent to those skilled in the art, and the generic principles defined herein may be applied to other embodiments without departing from the spirit or scope of the invention. Thus, the present invention is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims.

1. A septic system comprising:
a septic tank;
at least one liquid permeable leaching channel positioned below a ground surface and having a first end operatively connected to the septic tank and a second end; and
at least one reservoir, the reservoir comprising:
at least one wall having a top end and a bottom end, the wall defining an opening at the top end of the at least one wall;
a floor connected to the bottom end of the at least one wall;
an internal cavity defined by the at least one wall and the floor; and
an inlet passing into the internal cavity above the floor,
the at least one reservoir positioned partially in the ground such that the top end of the reservoir is positioned above the ground surface and the bottom end of the reservoir is positioned below the ground surface, the inlet of the reservoir operatively connected to the second end of the at least one leaching channel.

2. The septic system of claim 1 having a plurality of leaching channels with a reservoir connected to each of the plurality of leaching channels.

3. The septic system of claim 2 wherein each reservoir has an outlet and the outlet is operatively connected to an overflow leaching channel.

4. The septic system of claim 3 wherein the outlet is provided above the inlet of the reservoir.

5. The septic system of claim 1 wherein the at least one reservoir further comprises a plurality of protrusions extending outwards from the at least one wall to help secure the reservoir in the ground.

6. The septic system of claim 1 wherein the at least one wall of the at least one reservoir comprises an outer layer and an inner layer encapsulating an insulating layer between the outer layer and the inner layer.

7. The septic system of claim 6 wherein the floor comprises an outer layer and an inner layer encapsulating an insulating layer between the outer layer and the inner layer.

8. The septic system of claim 1 wherein the at least one reservoir further comprises a lip extending inwards from the at least one wall below the opening whereby a first lit can be placed on the lip and a second lid can be placed over the opening.

9. The septic system of claim 1 where the at least one reservoir further comprises a lid and a level indicator, the level indicator for indicating a level of effluent in the reservoir without having to remove the lid.

10. The septic system of claim 9 wherein the level indicator has a pole with a first end and a second end and a float is attached to the first end of the pole and wherein when the level indicator is provided with the float inside the at least one reservoir and the pole is extending upwards through an aperture in the lid so that the second end of the pole is above the reservoir, the height of the second end of the pole can indicate the level of effluent in the at least one reservoir.

11. A reservoir for connection to the end of a leaching channel, the reservoir comprising:
at least one wall having a top end and a bottom end, the wall defining an opening at the top end of the at least one wall;
a floor connected to the bottom end of the at least one wall;
an internal cavity defined by the at least one wall and the floor;
an inlet passing into the internal cavity above the floor; and
a plurality of protrusions extending outwards from the at least one wall to help secure the reservoir in the ground.

12. The reservoir of claim 11 wherein the at least one wall comprises an outer layer and an inner layer encapsulating an insulating layer between the outer layer and the inner layer.

13. The reservoir of claim 12 wherein the floor comprises an outer layer and an inner layer encapsulating an insulating layer between the outer layer and the inner layer.

14. The reservoir of claim 11 further comprising a lip extended inwards from the at least one wall below the opening whereby a first lit can be placed on the lip and a second lid can be placed over the opening.

15. The reservoir of claim 11 further comprising an outlet passing out of the internal cavity.

16. The reservoir of claim 15 wherein the outlet is provided above the inlet.

17. The reservoir of claim 11 further comprising a lid.

18. The reservoir of claim 17 further comprising a level indicator for indicating a level of effluent in the reservoir without having to remove the lid.

19. The reservoir of claim 18 wherein the level indicator has a pole with a first end and a second end and a float is attached to the first end of the pole and wherein when the level indicator is provided with the float inside the reservoir and the pole is extending upwards through an aperture in the lid so that the second end of the pole is above the reservoir, the height of the second end of the pole can indicate the level of effluent in the reservoir.
